(19) United States
(12) Patent Application Publication
(10) Pub. No.: US 2007/0253616 A1
(43) Pub. Date: Nov. 1, 2007

(54) MARK IMAGE PROCESSING METHOD, PROGRAM, AND DEVICE

(75) Inventor: Kazumi SUTO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/771,587

(22) Filed: Jun. 29, 2007

Related U.S. Application Data
(63) Continuation of application No. PCT/JP05/01595, filed on Feb. 3, 2005.

(51) Int. Cl. G06K 9/00

(52) U.S. Cl. 382/151

(57) ABSTRACT

A mark image processing device has an imaging control unit which captures images of an alignment mark on a work a plurality of times while changing an image capturing condition such as lighting intensity or exposure time by an imaging device and an image recognition unit which computes correlation between the plurality of images and a template image of the mark, which is registered in advance, and detects an optimal mark position. Each time the image capturing condition is changed within a predetermined range and the image of the mark is captured, the image recognition unit computes correlation at each slide position while causing the template image to slide with respect to the image, detects a mark position from the slide position at which the correlation value is the smallest, saves that together with the correlation value, detects the mark position having the smallest correlation value as an optimal value from the plurality of correlation values which are saved when the image capturing in which the image capturing condition is changed within a predetermined range is finished.

This application is a continuation of PCT/JP2005/001595 filed Feb. 3, 2005.

### TECHNICAL FIELD

The present invention relates to mark image processing method,program, and device which capture images of a fine alignment mark formed on a substrate or a chip and detect mark positions through an imaging process and, in particular, relates to mark image processing method, program, and device which recognize the alignment mark by matching between the images and a template image and detect mark positions.

### BACKGROUND ART

Conventionally, in semiconductor manufacturing equipment or assembling equipment such as a head gimbal assembly of a hard disk, when a work such as a substrate or a chip is to be carried to and positioned on an alignment stage on the equipment, an image of an alignment mark provided on the work is captured by an imaging device such as a CCD camera, and the alignment mark is recognized by a matching process between a template of an alignment mark which is registered in advance and the image so as to detect the mark position.

Such an alignment mark is a fine mark, which is for example about several tens of μm to several hundreds of μm, and generated by fine processing such as an edging process of a substrate.

When the image of the alignment mark is to be captured, optimal lighting conditions and exposure time, which are adjusted in advance, are fixedly used so as to capture the image of the alignment mark, recognize the mark by the imaging process, and detect the position.

Also, the image can be captured under optimal conditions by utilizing an automatic adjustment function of exposure time that a general digital still camera has.

However, in such conventional image recognition methods of the alignment mark, even when the image is captured by fixedly determined optimal lighting intensity and exposure time, the image of the state of the alignment mark which is formed by fine processing and the periphery thereof cannot be always captured under assumed optimal conditions due to the state of the chip surface forming the alignment mark, output variation of lighting, etc.

Therefore, since the image capturing conditions are not in conformity with the actual state of the alignment mark, there are problems that detection of the alignment mark based on the image is difficult or, even when it can be detected, the mark position cannot be precisely detected.

Moreover, in the automatic adjustment function of the exposure time that the general digital still camera has, the amount of light is evaluated by using the entire screen or particular plural locations as an evaluation range; therefore, when an image of the alignment mark is to be captured, since the position thereof is undetermined, the automatic adjustment function of the exposure time in which the evaluation location is determined cannot be considered to be practical.

It is an object of the present invention to provide mark image processing method, program, and device which recognize a mark position from an image according to optimal conditions which are in conformity with the state at the point without being affected by the formation state of the alignment mark, lighting variation, etc.

### DISCLOSURE OF INVENTION

The present invention provides a mark image processing method. The mark image processing method of the present invention is characterized by including

an imaging control step of capturing images of a mark on a work a plurality of times while changing an image capturing condition of an imaging device; and

an image recognition step of computing correlation between the plurality of images and a template image of the mark which is registered in advance and detecting an optimal mark position.

Herein, in the imaging step, the images of the mark are captured a plurality of times while changing lighting intensity within a predetermined range. Also, in the imaging step, the images of the mark are captured a plurality of times while changing exposure time within a predetermined range. Furthermore, in the imaging step, images of the mark may be captured a plurality of times while changing lighting intensity of a lighting device and exposure time within a predetermined range.

In the image recognition step, each time the image capturing condition is changed within a predetermined range and the image of the mark is captured, correlation is computed at each slide position while causing the template image to slide with respect to the image, a mark position is detected from the slide position at which a correlation value is the smallest and saved together with the correlation value, and a mark position having the smallest correlation value is detected as an optimal value from the plurality of correlation values which are saved when the image capturing in which the image capturing condition is changed within the predetermined range is finished. The mark is an alignment mark formed on a substrate or a chip by fine processing.

The present invention provides a program for mark image processing. The program of the present invention is characterized by causing a computer to execute

an imaging control step of capturing images of a mark on a work a plurality of times while changing an image capturing condition of an imaging device; and

an image recognition step of computing correlation between the plurality of images and a template image of the mark which is registered in advance and detecting an optimal mark position.

The present invention provides a mark image processing device. The mark image processing device of the present invention is characterized by having

an imaging control unit which captures images of a mark on a work a plurality of times while changing an image capturing condition of an imaging device; and

an image recognition unit which computes correlation between the plurality of images and a template image of the mark which is registered in advance and detects an optimal mark position.

Note that details of the program and device of the mark image processing according to the present invention are basically same as the case of the mark image processing method.

According to the present invention, when an image of a fine alignment mark on a substrate or a chip is to be captured, lighting intensity and/or exposure time is changed within a range, which is set in advance, as an image capturing condition(s), the images captured at the respective image capturing conditions and a template registered in advance are subjected to correlation computing, the part at which the correlation value is the smallest is obtained as a mark position therefrom, and the mark position at which the correlation value is the smallest is set as an optimal solution from the mark positions of the images; thus, even when there are various variations in the formation state of the fine alignment mark, the mark position of which image is captured under optimal conditions can be always recognized, and recognition precision can be significantly improved.

Moreover, when a work is changed or when a production lot is different even when it is the same work, in conventional methods, adjustment for obtaining optimal image capturing conditions has been required every time; however, in the present invention, the image capturing conditions are not required to be adjusted again with respect to change of the conditions of the work, and management is simple and easy.

### BRIEF DESCRIPTION OF DRAWINGS

FIG. 1 is an explanatory diagram of an ultrasonic bonding device in which a mark image processing device of the present invention is used;

FIG. 2 is an explanatory diagram of a functional configuration of the mark image processing device of the present invention;

FIG. 3 is an explanatory diagram of an imaging device of FIG. 2 having a lighting device;

FIG. 4 is an explanatory diagram of a work on which alignment marks to be processed by the present invention are formed;

FIGS. 5A and 5B are explanatory diagrams of correlation computing which is performed by causing a template image to slide with respect to a mark image;

FIG. 6 is a flow chart of a mark image recognition process according to a first embodiment of the present invention in which lighting intensity is changed to capture images;

FIG. 7 is a flow chart of a mark image recognition process according to a second embodiment of the present invention in which exposure time is changed to capture images; and

FIGS. 8A and 8B are flow charts of a mark image recognition process according to a third embodiment of the present invention in which the lighting intensity and the exposure time are changed to capture images.

### BEST MODE FOR CARRYING OUT THE INVENTION

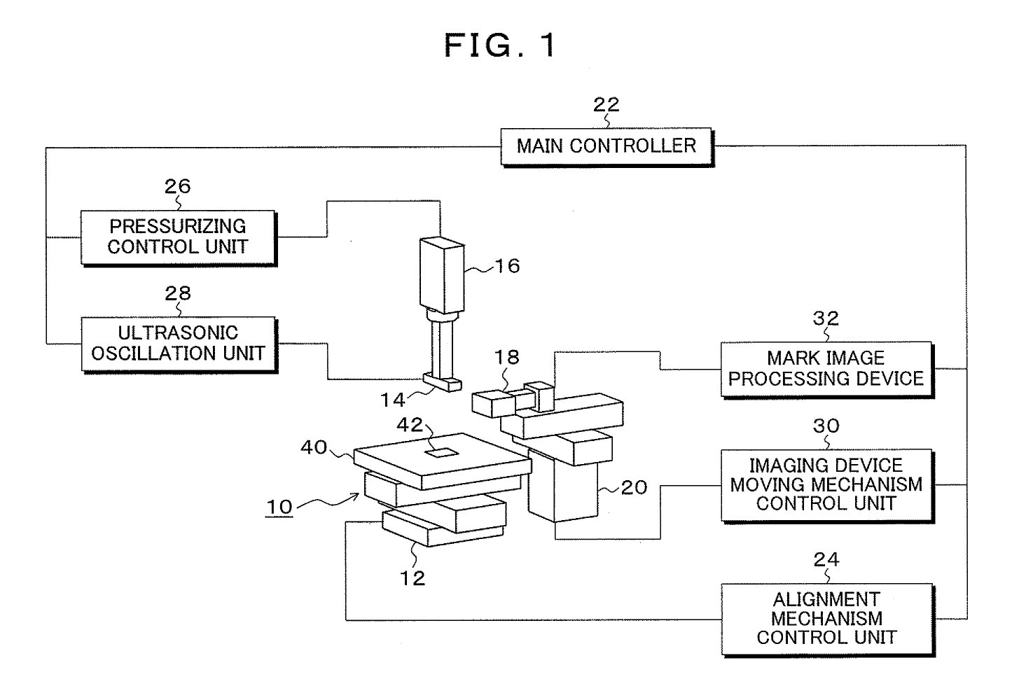

FIG. 1 is an explanatory diagram of an ultrasonic bonding device to which a mark image processing device of the present invention is applied. In FIG. 1, the ultrasonic bonding device 10 has an alignment mechanism 12, a pressurizing mechanism 16 having an ultrasonic head 14 at a distal end and an imaging device 18 are provided with respect to the alignment mechanism 12, and the mark image processing device 32 of the present invention is connected to the imaging device 18.

In the alignment mechanism 12, a work 42 is mounted on an alignment stage 40, and the alignment mechanism 12 has a mechanism which moves the alignment stage 40 in an X direction and a Y direction which are orthogonal to each other in the horizontal direction and in a vertical Z direction and causes the stage surface to incline at an angle of θ with respect to the horizontal surface.

On the work 42 mounted on the alignment stage 40, an alignment mark for positioning the work 42 to a predetermined processing position is formed, an image of the alignment mark is captured by the imaging device 18, the position of the alignment mark is detected by the mark image processing device 32, the alignment stage 40 is driven by the alignment mechanism 12, and the work 42 is positioned and adjusted to the predetermined processing position with respect to the ultrasonic head 14.

An alignment mechanism control unit 24 is provided for the alignment mechanism 12 so that the alignment stage 40 can be driven in the directions of X, Y, Z, and the angle θ with respect to the horizontal surface.

An imaging device moving mechanism 20 is provided for the imaging device 18, and the imaging device moving mechanism 20 can move the imaging device 18 in the X direction and the Y direction, which are orthogonal to each other in the horizontal surface, by an imaging device moving mechanism control unit 30.

An ultrasonic oscillation unit 28 is provided for the ultrasonic head 14, the ultrasonic head 14 is driven by an output signal from an ultrasonic oscillator provided in the ultrasonic oscillation unit 28, and a bonding part of the work is subjected to bonding processing by ultrasonic oscillation in the state in which the ultrasonic head 14 is mechanically pressed against the work 42.

The pressurizing mechanism 16 provided for the ultrasonic head 14 drives the ultrasonic head 14 in the vertical direction, i.e., the Z direction, and performs bonding by pressing the ultrasonic head 14 against the work 42 and changing the ultrasonic signal. The pressurizing mechanism 16 is controlled by the pressurizing control unit 26.

A main controller 22 controls the alignment mechanism control unit 24, the pressurizing control unit 26, the ultrasonic oscillation unit 28, the imaging device moving mechanism control unit 30, and the mark image processing device 32 in accordance with a predetermined procedure and controls a series of operations from carry-in until ultrasonic bonding and removal of the work 42 in the ultrasonic bonding device 10.

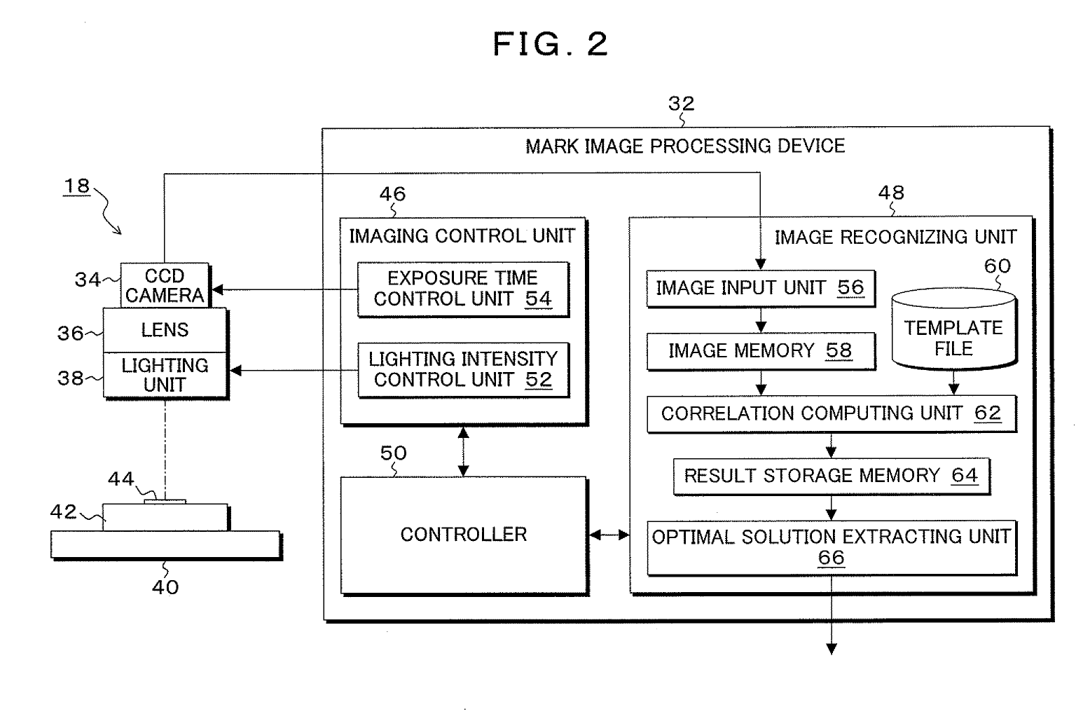

FIG. 2 is an explanatory diagram showing a functional configuration of the mark image processing device of the present invention provided in the ultrasonic bonding device 10 of FIG. 1.

In FIG. 2, the imaging device 18 is composed of a CCD camera 34, a lens 36, and a lighting unit 38 and captures images of the alignment mark 44 of the work 42 mounted on the alignment stage 40. An imaging control unit 46 and an image recognition unit 48 are provided in the work image processing device 32, and each of them is controlled by a controller 50 in accordance with a predetermined processing procedure.

A lighting intensity control unit 52 and exposure time control unit 54 are provided in the imaging control unit 46, and, in a first embodiment of the present invention, images of the alignment mark 44 are captured a plurality of times while changing the lighting intensity of the lighting unit 38 provided in the imaging device 18 within a predetermined range by the lighting intensity control unit 52. In this course, the exposure time of the CCD camera 34 by the exposure time control unit 54 is fixed to optimum exposure time which is set in advance.

Also, in a second embodiment of the present invention, images of the alignment mark 44 are captured a plurality of times while changing the exposure time within a predetermined range by the exposure time control unit 54. In this course, the lighting intensity control unit 52 fixedly sets optimal lighting intensity which is adjusted in advance.

Furthermore, in a third embodiment of the present invention, the lighting intensity control unit 52 and the exposure time control unit 54 are controlled at the same time and images of the alignment mark 44 are captured a plurality of times while changing the lighting intensity within a predetermined range and while changing the exposure time within a predetermined range.

The image recognition unit 48 computes correlation between the images, which are obtained by capturing images of the alignment mark 44 a plurality of times while changing the image capturing conditions of the imaging device 18 by the imaging control unit 46, and a template image of the alignment mark, which is registered in advance, so as to detect an optimal mark position. Therefore, in the image recognition unit 48, an image input unit 56, an image memory 58, a template file 60, a correlation computing unit 62, a result storage memory 64, and an optimal solution extracting unit 66 are provided.

The image input unit 56 inputs the images captured by the imaging device 18 along with change of the lighting intensity and exposure time by the imaging control unit 46 and records them in the image memory 58. In the template file 60, the template image including an image of the alignment mark 44 is registered in advance.

The correlation computing unit 62 computes the correlation at each slide position while causing the template image of the template file 60 to slide with respect to the image stored in the image memory 58, detects the mark position from the slide position at which the correlation value is minimum, and saves that in the result storage memory 64 together with the correlation value at that point.

In the present invention, for example ten times of image capturing is performed for one alignment mark 44 while changing, for example, the lighting intensity, and, in accordance with that, for example, ten images of the same alignment mark 44 are saved in the image memory 58.

The correlation computing unit 62 computes correlation with respect to the template image for each of the ten images, detects the mark position at which the correlation value is minimum from the slide position of the template, and stores that in the result storage memory 64 together with the correlation value at that point. Therefore, for example for ten images which are captured while changing the lighting intensity, ten correlation values obtained for the ten images through correlation computing by the correlation computing unit 62 are stored in the result storage memory 64 together with work positions.

The optimal solution extracting unit 66 extracts the mark position having a minimum correlation value as an optimal value from the correlation values which are stored in the result storage memory 64 for, for example, ten images captured when the lighting intensity is changed ten times within a predetermined range and outputs that to outside.

The mark detection position serving as an optimal solution output to the outside is given to, for example, the alignment mechanism 12 of FIG. 1, the alignment mechanism 12 is adjusted so that the work 42 on the alignment stage 40 achieves specified position relation with respect to the ultrasonic head 14, the ultrasonic head 14 is lowered onto the work 42 by the pressurizing control unit 26 in the state in which the alignment adjustment is finished and it is pushed up, and, when an ultrasonic signal is supplied from the ultrasonic oscillation unit 28 to the ultrasonic head 14 and it is oscillated, a predetermined bonding part on the work 42 can be subjected to ultrasonic bonding.

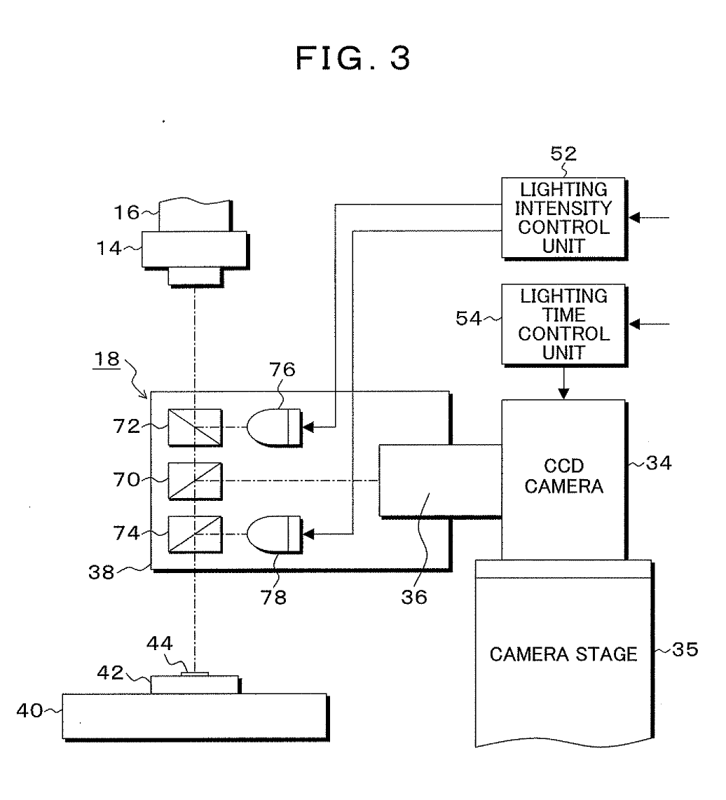

FIG. 3 is an explanatory diagram of the imaging device 18 of FIG. 2 having the lighting unit. In FIG. 3, in the imaging device 18, the lighting unit 38 is attached to a distal end part of the lens 36 provided in the CCD camera 34. In the lighting unit 38, abeam splitter 70 is disposed on the optical axis of the lens 36, beam splitters 72 and 74 are disposed above that, and LED lighting units 76 and 78 are provided for the beam splitters 72 and 74, respectively.

The exposure time control unit 54 is provided for the CCD camera 34, and the lighting intensity control unit 52 is provided for the LED lighting units 76 and 78. When the lighting intensity control unit 52 causes merely the LED lighting unit 78 to be lit, an image of the alignment mark 44 of the work 42 mounted on the alignment stage 40 is captured by the CCD camera 34. When the LED lighting unit 76 is lit, an image of merely the ultrasonic head 14 is captured.

When the LED lighting unit 78 is lit, the illumination light from the LED lighting unit 78 is downwardly reflected by the beam splitter 74, thereby irradiating the work 42 on which the alignment mark 44 is formed. The reflected light caused by illumination of the work 42 permeates through the beam splitter 74, is then reflected by the beam splitter 70 in a lateral direction, is injected into the CCD camera 34 via the lens 36, and forms an image of the work 42, thereby performing image capturing.

Meanwhile, when the LED lighting unit 76 is lit, the illumination light is upwardly reflected by the beam splitter 72 and irradiates a screen of the ultrasonic head 14. Therefore, the reflected light of the irradiated screen of the ultrasonic head 14 permeates through the beam splitter 72, is injected into the lighting unit 38, is then reflected in a left direction, is reflected by a left end face, then returns to the right side, is injected into the CCD camera 34 via the lens 36, and forms an image of the screen of the ultrasonic head 14.

The CCD camera 34 captures the image of the alignment mark 44 of the work 42 and the image of the screen of the ultrasonic head 14 through lighting switch of the LED lighting units 76 and 78, and the position of the alignment stage 40 is adjusted so that the work position detected from the image of the alignment mark 44 is matched with a specified position of the image of the ultrasonic head 14.

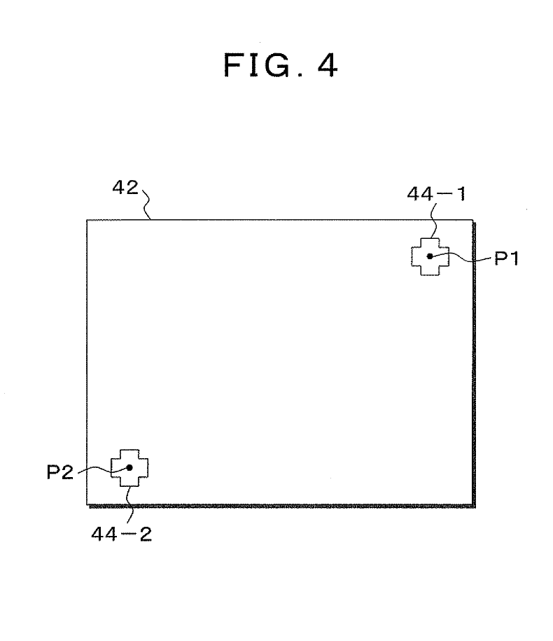

FIG. 4 is an explanatory diagram of alignment marks formed on the work 42 of FIG. 3. The work 42 of FIG. 4 is a substrate or a chip on which a semiconductor integrated circuit is formed, and, in this example, alignment marks 44-1 and 44-2 are formed at two locations, an upper right corner and a lower left corner, by fine processing such as edging.

The alignment marks 44-1 and 44-2 are cross marks in this example, and the size thereof is a fine size that is about 60 μm to 99 μm. Center positions P1 and P2 of the alignment marks 44-1 and 44-2 having cross shapes indicate the coordinate points of mark detection positions.

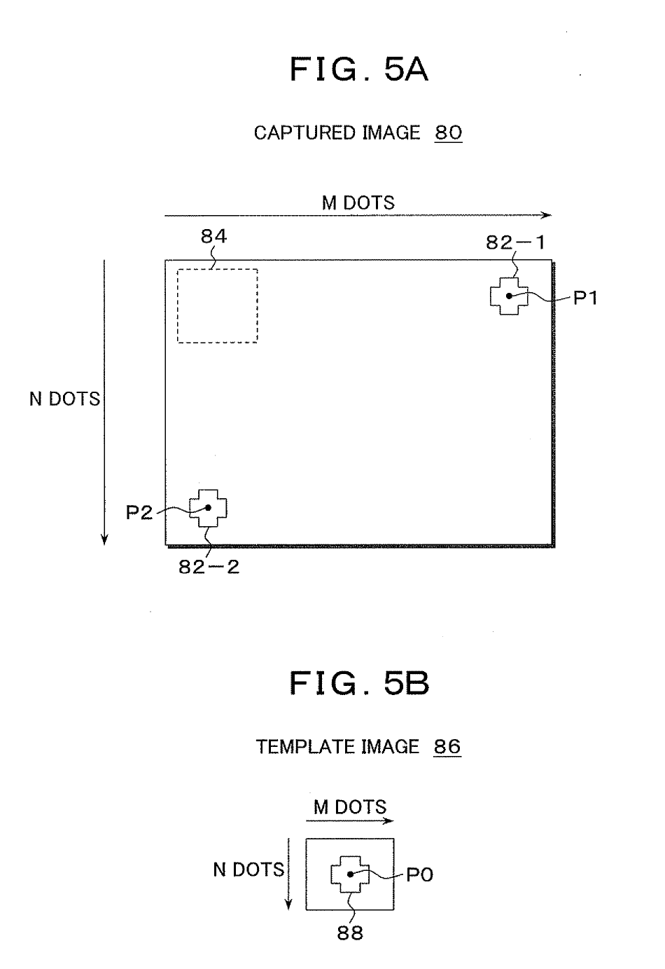

FIGS. 5A and 5B are explanatory diagrams of correlation computing which is performed by causing the template to slide with respect to a mark image. FIG. 5A is an image 80 capturing the work 42 of FIG. 4, and it has an image size of, for example, lateral M dots and vertical N dots. Mark images 82-1 and 82-2 of the alignment marks are present at two locations of the image 80, and they respectively have the center points P1 and P2 which serve as mark detection positions.

FIG. 5B is a template image 86, wherein it has an image size of lateral m dots and vertical n dots, which is a size smaller than that of the image 80 of FIGS. 5A and 5B, a reference mark image 88 is disposed at a center position, and the center thereof is a reference center point P0 which provides a reference detection position.

Regarding correlation computing, a clipped region 84 having the same size as the template image 86 of FIG. 5B is clipped as an image from the image 80 of FIGS. 5A and 5B wherein, for example, a coordinate point of the left corner of the image 80 serves as an initial position, and correlation computing of the clipped image of the clipped region 84 and the template image 86 is performed.

When the correlation computing of the template image 86 with respect to the clipped region 84 is finished, correlation computing of the images of clipped regions and the template image 86 is similarly repeated while shifting the clipped region 84 one dot each time in a lateral direction. When the clipped region 84 reaches the right end, it is returned to the left end and shifted by one dot in the vertical direction, and correlation computing with respect to the template image 86 is performed at each slide position while it is similarly slid from left to right.

In this course, the correlation computing of the clipped images of clipped region 84 and the template image 86 is performed by the following expression.

$$D ( u , v ) = {\sum }_{i = 1}^{m} {\sum }_{i = 1}^{n} \{ I ( X , Y ) - I ( x , y ) \} \qquad Expression 1$$

Note that C is a correlation value, (u,v) is a coordinate position of the correlation value C, and I(X,Y) is an object value in the position image of the clipped image. I(x,y) is an object value of the position image of the template image 86.

When the clipped region 84 is slid with respect to the image 80 in this manner from the left corner to a last position at the lower right corner while performing scanning in the horizontal and vertical directions, and a correlation calculation with respect to the template image 86 is performed at each slide position to obtain a correlation value, correlation values that are minimum values are obtained at two locations in the vicinity of the mark image 82-1 and in the vicinity of the mark image 82-2, the two correlation values that are the minimum values are stored in the result storage memory 64, which is provided in the image recognition unit 48 of FIG. 2, together with the mark detection positions provided by the coordinates of P1 and P2.

Then, for example from minimum correlation values obtained from ten images captured while changing the lighting intensity ten times within a predetermined range, the mark detection position having the smallest correlation value is output as an optimal solution,

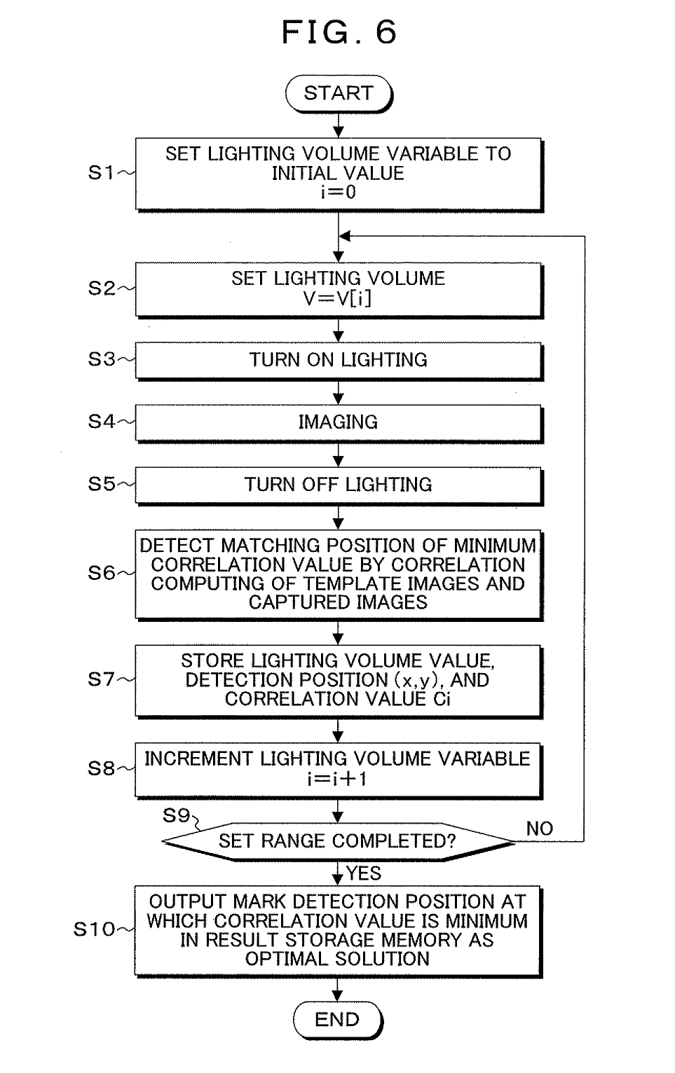

FIG. 6 is a flow chart of a mark image recognition process according to the first embodiment of the present invention in which image capturing is performed while changing the lighting intensity. In FIG. 6, in step S1, a lighting volume variable i representing the lighting intensity is set to i=0 which is an initial value. Subsequently, in step S2, a lighting volume is set to V=V[0].

Herein, the volume variable i is set so that the lighting volume, i.e., the lighting intensity is changed in ten levels within the range that is, for example, ±5% around the value of experiential and statistical optimal lighting intensity which is fixedly set when the image capturing conditions are not changed. The exposure time in this case fixedly utilizes optimal exposure time which is experientially and statistically obtained.

When the first volume setting is finished in step S2, the process proceeds to step S3 in which the lighting is turned on. In this lighting, the LED lighting unit 78 in FIG. 3 is turned on. As a result, the light from the LED lighting unit 78 is reflected by the beam splitter 74 and irradiated onto the work 42; and the lighting unit reflected light on the work 42 permeates through the beam splitter 74, is reflected by the beam splitter 70, is injected into the CCD camera 34, and forms a captured image of the alignment mark 44.

Next, in step S4, image capturing by exposure reading of the CCD camera 34 is performed, and images of an alignment mark are input; and the lighting is turned off in step S5. Subsequently, in step S6, a most-matched position at which the correlation value is the smallest is detected through correlation computing between the template image and the images; and, in step S7, the lighting volume value of the matching position, coordinates (x,y) representing the detection position, and the correlation value Ci serving as a matching score are stored in the storage result memory 64.

Next, after the volume variable is incremented, i=i+1, whether it is completed or not is checked in step S9; and, if it is not completed, the process returns to step S2, and the processes of steps S2 to S8 based on an image capturing process based on setting of the lighting volume that is newly set.

When set range completion of the lighting volume is determined in step S9, the process proceeds to step S10 in which the position at which the correlation value as a matching score is the smallest in the data in the result storage memory 64 is extracted and output as a mark detection position which serves as an optimal solution.

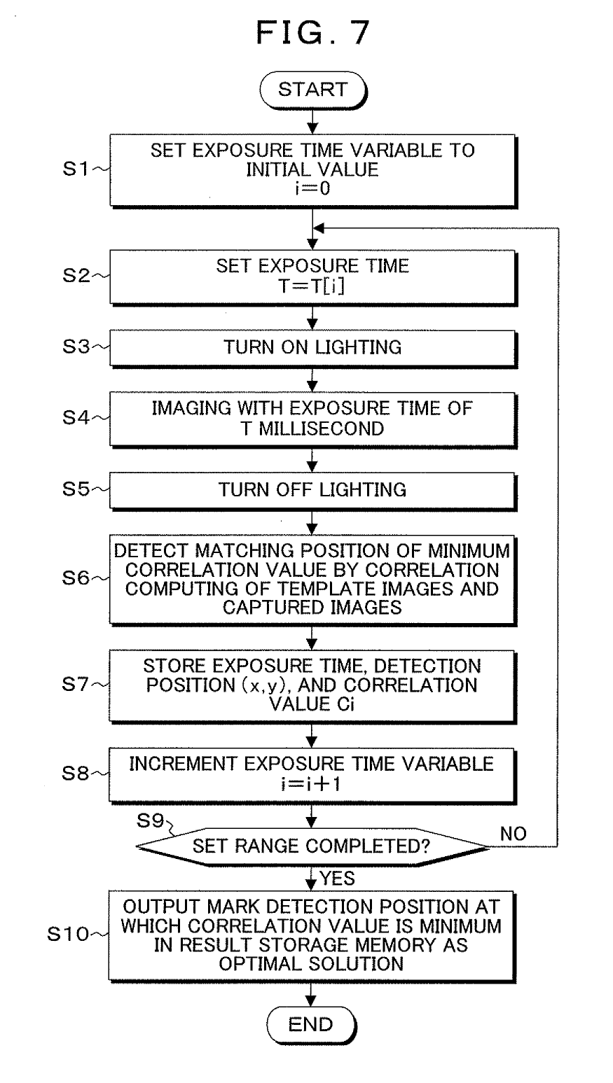

FIG. 7 is a flow chart of a mark image recognition process in the second embodiment of the present invention in which image capturing is performed while changing the exposure time. In FIG. 7, in step S1, an exposure time variable i is set to an initial value of i=0. Subsequently, in step S2, T=T[0] is set as the exposure time T.

Herein, the exposure time is set in advance so that it is changed in ten levels within the range that is, for example, ±5% around the value of experiential and statistical optimal exposure time which is fixedly set when the image capturing conditions are not changed. Subsequently, the lighting is turned on in step S3. The lighting intensity in this case fixedly uses optimal lighting intensity which is experientially and statistically obtained.

Subsequently, in step S4, image capturing is performed for set exposure time T millisecond, and the lighting is turned off in step S5. Subsequently, instep S6, the most matched position having a minimum correlation value is detected through correlation computing between the template image and the captured images; and, in step S7, the exposure time T, the detection position (x,y), and the detection position Ci serving as a matching score are stored.

Subsequently, after the exposure time variable is incremented to i−i+1 in step S8, whether a set range is completed or not is checked in step S9; and, if it is not completed, the process returns to step S2, and the processes of steps S2 to S8 are similarly repeated by the setting according to a next exposure time variable.

If the set range is completed in step S9, the process proceeds to step S10, and the position, i.e., mark detection position at which the correlation value is the smallest is extracted from the result storage memory 64 at that point and output as an optimal solution.

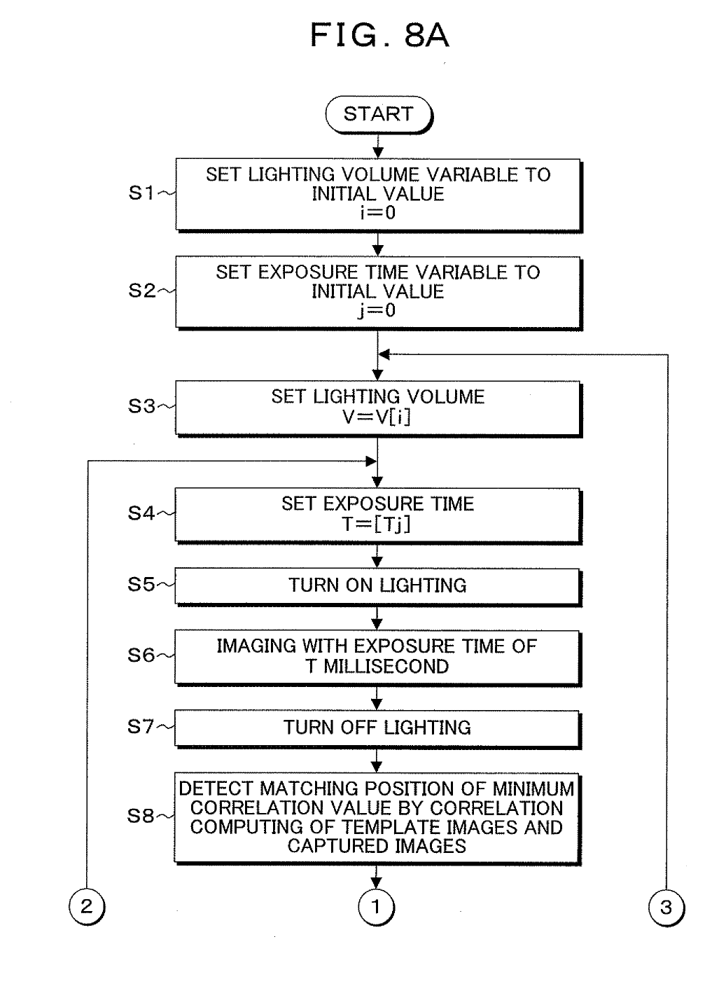

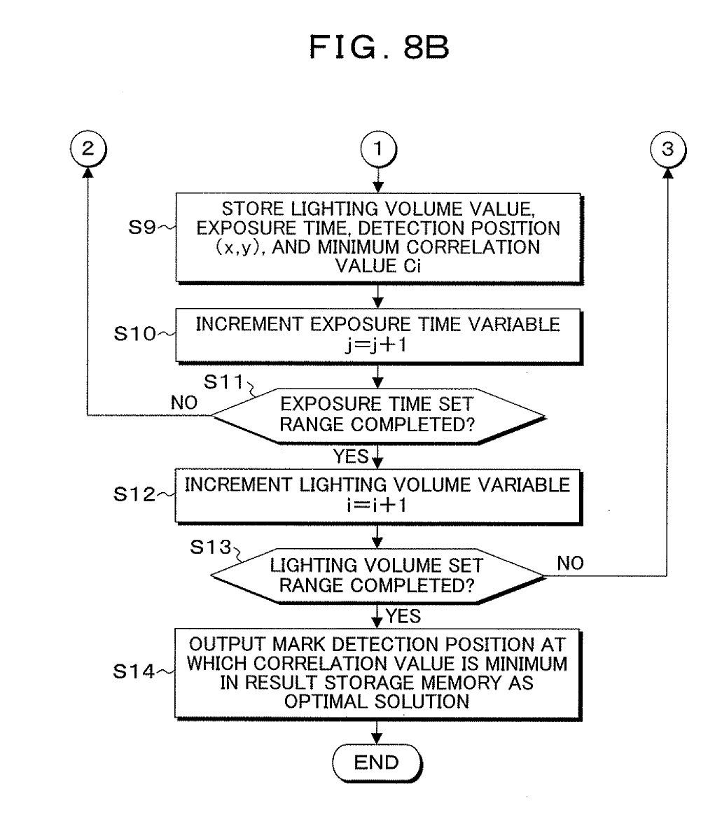

FIGS. 8A and 8B are flow charts of a mark image recognition process according to the third embodiment of the present invention in which image capturing is performed while changing the lighting intensity and exposure time. In FIGS. 8A and 8B, in the first place, in step S1, a lighting volume variable i is set to an initial value i=0. Next, in step S2, an exposure time variable j is set to an initial value j=0. Next, after the lighting volume V is set to V=V[i] in step S3, the exposure time T is set to T=T[j] in step S4.

Subsequently, in step S5, the lighting is turned on at the intensity of the set value of the lighting volume at that point; in step S6, image capturing is performed for exposure time T milliseconds set at that point; and, in step S7, the lighting is turned off. Next, in step S8, the most matching position at which the correlation value is the smallest is detected through correlation computing between the template image and the images; and, in step S9, the lighting volume value, the exposure time, the detection position (x,y), and the minimum correlation value Ci serving as a matching score are stored in the result storage memory 64.

Subsequently, after the exposure time variable is incremented to j=j+1 in step S10, whether the exposure time set range is completed or not is checked in step S11; and, if it is not completed, the process returns to step S4, and the processes of steps S4 to S10 are repeated.

If the exposure time set range is completed in step S11, the process proceeds to step S12 in which the lighting volume variable is incremented to i=i+1. Then, whether the lighting volume set range is completed or not is checked in step S13, and, if it is not completed, the process returns to step S3, and the processes of steps S3 to S12 are repeated.

If the lighting volume set range is completed in step S13, the process proceeds to step S14 in which the position at which the correlation value as a matching score is the smallest is extracted and output as an optimal solution of the mark detection position from the data stored in the result storage memory 64 at that point.

When each of the numbers of the change times of the lighting volume and the exposure time in the set range in the third embodiment of FIGS. 8A and 8B is ten times, the detection position having the minimum correlation value is respectively obtained through correlation computing for the images which are captured through 100 times of image capturing in total, and the mark detection position having the smallest correlation value is extracted therefrom as an optimal solution.

When both the lighting volume and the exposure time are changed in this manner, since the number of the times of image capturing including the number of levels in addition to the number of adjustment of operations is large, the processing time may be shortened, for example, by reducing the number of times of overall image capturing by respectively reducing the number of adjustment times to five in the case of the third embodiment compared with the first embodiment and the second embodiment wherein the number of times of adjustment is 10.

Moreover, in the third embodiment of FIGS. 8A and 8B, the process of capturing images while changing the exposure time within a predetermined range wherein an adjustment volume is set is repeated; however, inversely, a process of changing the adjustment volume in a predetermined range wherein the exposure time is set may be repeated.

Furthermore, the present invention provides a program of mark image processing for an alignment mark, and this program is executed by a hardware environment of a computer which constitutes the mark image process device 32 of FIG. 2.

More specifically, the mark image process 32 of FIG. 2 is realized by the hardware environment of the computer; in such a computer, a ROM, a RAM, and a hard disk drive are connected to a bus of a CPU; the mark image processing program according to the present invention is loaded in the hard disk drive; and, upon start-up of the computer, the mark image processing program of the present invention is read from the hard disk drive, deployed to the ROM, and executed by the CPU.

The mark image processing program of the present invention executed by the hardware environment of the computer has a processing procedure shown in the flow chart of FIG. 6, FIG. 7, or FIGS. 8A and 8B.

Note that, the above described embodiments take the case in which they are applied to the ultrasonic bonding device as the mark image processing device 32 as an example; however, the present invention is not limited to that, and the present invention can be applied to an arbitrary device without modification as long as the device detects the position by capturing images of a fine alignment mark on a circuit board or a chip by an imaging device.

The present invention also includes arbitrary modifications that do not impair the object and advantages thereof and is not limited by the numerical values shown in the above described embodiments.

1. A mark image processing method characterized by including
an imaging control step of capturing images of a mark on a work a plurality of times while changing an image capturing condition of an imaging device; and
an image recognition step of computing correlation between the plurality of images and a template image of the mark which is registered in advance and detecting an optimal mark position.

2. The mark image processing method according to claim 1, characterized in that, in the imaging control step, the images of the mark are captured a plurality of times while changing lighting intensity within a predetermined range.

3. The mark image processing method according to claim 1, characterized in that, in the imaging control step, the images of the mark are captured a plurality of times while changing exposure time within a predetermined range.

4. The mark image processing method according to claim 1, characterized in that, in the imaging control step, images of the mark are captured a plurality of times while changing lighting intensity of a lighting device and exposure time within a predetermined range.

5. The mark image processing method according to claim 1, characterized in that, in the image recognition step, each time the image capturing condition is changed within a predetermined range and the image of the mark is captured, correlation is computed at each slide position while causing the template image to slide with respect to the image, a mark position is detected from the slide position at which a correlation value is the smallest and saved together with the correlation value, and a mark position having the smallest correlation value is detected as an optimal value from the plurality of correlation values which are saved when the image capturing in which the image capturing condition is changed within the predetermined range is finished.

6. The mark image processing method according to claim 1, characterized in that the mark is an alignment mark formed on a substrate or a chip by fine processing.

7. A computer-readable storage medium which stores a program characterized by causing a computer to execute:
an imaging control step of capturing images of a mark on a work a plurality of times while changing an image capturing condition of an imaging device; and
an image recognition step of computing correlation between the plurality of images and a template image of the mark which is registered in advance and detecting an optimal mark position.

8. The storage medium according to 7, characterized in that, in the imaging control step, the images of the mark are captured a plurality of times while changing lighting intensity within a predetermined range.

9. The storage medium according to claim 7, characterized in that, in the imaging control step, the images of the mark are captured a plurality of times while changing exposure time within a predetermined range.

10. The storage medium according to claim 7, characterized in that, in the imaging control step, images of the mark are captured a plurality of times while changing lighting intensity of a lighting device and exposure time within a predetermined range.

11. The storage medium according to claim 7, characterized in that, in the image recognition step, each time the image capturing condition is changed within a predetermined range and the image of the mark is captured, correlation is computed at each slide position while causing the template image to slide with respect to the image, a mark position is detected from the slide position at which a correlation value is the smallest and saved together with the correlation value, and a mark position having the smallest correlation value is detected as an optimal value from the plurality of correlation values which are saved when the image capturing in which the image capturing condition is changed within the predetermined range is finished.

12. The storage medium according to claim 7, characterized in that the mark is an alignment mark formed on a substrate or a chip by fine processing.

13. A mark image processing device characterized by having
an imaging control unit which captures images of a mark on a work a plurality of times while changing an image capturing condition of an imaging device; and
an image recognition unit which computes correlation between the plurality of images and a template image of the mark which is registered in advance and detects an optimal mark position.

14. The mark image processing device according to claim 13, characterized in that, the imaging device captures the images of the mark a plurality of times while changing lighting intensity within a predetermined range.

15. The mark image processing device according to claim 13, characterized in that, the imaging device captures the images of the mark a plurality of times while changing exposure time within a predetermined range.

16. The mark image processing device according to claim 13, characterized in that, the imaging device captures images of the mark a plurality of times while changing lighting intensity of a lighting device and exposure time within a predetermined range.

17. The mark image processing device according to claim 13, characterized in that, each time the image capturing condition is changed within a predetermined range and the image of the mark is captured, the image recognition unit computes correlation at each slide position while causing the template image to slide with respect to the image, detects a mark position from the slide position at which a correlation value is the smallest, saves the position together with the correlation value, and detects a mark position having the smallest correlation value as an optimal value from the plurality of correlation values which are saved when the image capturing in which the image capturing condition is changed within the predetermined range is finished.

18. The mark image processing device according to claim 13, characterized in that the mark is an alignment mark formed on a substrate or a chip by fine processing.
